(19) United States
(12) Patent Application Publication
(10) Pub. No.: US 2023/0364568 A1
(43) Pub. Date: Nov. 16, 2023

(54) IMPROVED STATIC MIXING TIP

(71) Applicant: MEDMIX SWITZERLAND AG, Haag(Rheintal) (CH)

(72) Inventors: Jim GIGER, Grabs (CH); Michaela NOACK, Satteins (CH); Joachim SHOECK, Winterthur (CH); Bettina SCHAUFFACHER, Wangs (CH); Nicole REY, Buchs (CH)

(21) Appl. No.: 18/029,887

(22) PCT Filed: Nov. 9, 2021
(86) PCT No.: PCT/EP2021/081041

§ 371 Date: Mar. 31, 2023

(30) Foreign Application Priority Data
Nov. 11, 2020 (EP) 20206952.2
Dec. 9, 2020 (EP) 20212745.2

(51) Int. Cl. B01F 35/00; B01F 25/432; B05C 17/005

(52) U.S. Cl. CPC B01F 35/189; B01F 25/4321; B05C 17/00553; B01F 2035/351

(57) ABSTRACT

A static mixing tip includes a static mixer, a housing and a body. A head space is between the housing and the static mixer, a sealing lip on the base of the static mixer seals between the base of the static mixer and the housing, and a venting element is on the sealing lip of the static mixer or the housing. The venting element provides gas flow communication between sides of the sealing lip, and a gaseous connection between the head space and an exterior ambient atmosphere such that gases trapped in the head space between the housing and the static mixer can escape during normal operation and operation of the static mixing tip.

### CROSS-REFERENCE TO RELATED APPLICATION

This application is a U.S. National Stage application of International Application No. PCT/EP2021/081041, filed Nov. 9, 2021, which claims priority to European Application No. 20206952.2, filed Nov. 11, 2020 and European Application No. 20212745.2, filed Dec. 9, 2020, the contents of each of which are hereby incorporated by reference.

### BACKGROUND

### Technical Field

The present disclosure relates to an improved static mixing tip comprising a venting element, a static mixer suitable for use in the static mixing tip, use of the static mixing tip to vent air to the ambient atmosphere while mixing components, and a kit of parts comprising the static mixing tip.

### Background Information

In the field of applicator systems, static mixing tips suitable for mixing two or more materials such as liquids or viscous masses containing adhesive or other reactive material components are known for industrial, construction and dental applications. For example, EP0584428B1 discloses helical static mixers, and EP1426099B1, EP0749776B1 and EP0815929B1 disclose various static mixers having quadratic-based mixing elements.

The components to be mixed and the resulting mixtures are valuable and potentially air sensitive and/or irritating, and their loss or spillage through leakage from the applicator system is therefore undesirable. For this reason, the static mixing tips as generally available from a variety of manufacturers on the market often have a tight-fitting seal with the outlet of the cartridge and have a tightly sealed construction themselves except for their outlet.

Although such tightly sealed tips prevent leakage, their tight sealing may introduce potential risks. For example, before the materials to be mixed enter the static mixing tip, air is present inside the tip. If this air does not exit the outlet of the mixing tip before the mixed materials, it may become trapped within the incoming materials and causes bubbles to form within the materials. Another source of air or gases can potentially be the material in the cartridges themselves. Air bubbles in the cartridge containers themselves may result from inadequate venting during cartridge filling or may develop due to subsequent processing of the material-filled cartridges, for example, by heating, freezing, sterilization or irradiation. Such air or gas bubbles are undesirable, as the presence of bubbles may inhibit the efficient mixing of the materials, and the resulting mixture may have localized inhomogeneities or inferior mixed product material attributes such as poor strength or adhesion or filling defects.

EP1896192A1 discloses a device and a method for venting the air trapped inside a static mixing tip based on a valve assembly, deviating channel or outlet, and a collecting container with a special filtering system to retain material but allow air to pass through. It is disclosed that the collecting container can even be connected to a further suction or vacuum device. This disclosed venting device is complex and requires significant space which may not be available when applying materials to small areas with restricted access and limited working space. In addition, the necessary handling operations such as making and ending connections, opening and closing of valves, or controlling suction devices can be challenging if the user is wearing gloves or other protection, hygienic or safely equipment. In addition, the reaction between the incoming materials to be mixed starts immediately as they come into contact with each other inside the mixing tip, so there is often not enough time to connect additional venting device(s) to or before the mixing tip and for carrying out an additional pre-application venting step before the mixture begins to harden or must be applied. With the solution disclosed in EP'192 A1, an efficient venting is complicated, requires special attention, and is challenging in the case of fast-reacting adhesives.

### SUMMARY

It has been determined that it can be difficult to force out the air trapped inside a static mixing tip in which none of the parts can be moved. A potential solution to this problem was disclosed in U.S. Pat. No. 5,498,078 which provides an inclined guiding surface which prevents the accumulation of possibly present air or gas and thus allegedly ensures evacuation of air and prevents the formation of air bubbles. However, this inclined surface increases the length of the static mixer as an additional surface needs to be provided on the static mixer, and it does not help to vent the air trapped in a headspace between the static mixer and the housing.

In light of the conventional art, the present disclosure provides a static mixing tip that produces homogeneous mixtures devoid of bubbles without the need to provide an additional venting device and auxiliary equipment.

Starting from this state of the art, the present disclosure provides a solution that can be applied to all types of static mixing tips and does not increase the length of the mixer. It has been surprisingly found that the present disclosure provides a simple and cost-effective solution to vent the trapped air from a static mixing tip by providing vents on the sealing lip and/or the housing of the static mixing tip. This solution can be applied to a static mixing tip with any geometry.

According to the disclosure, these objects are achieved by the static mixing tip having one or more venting means or elements which are present on the sealing lip of the static mixer and/or the housing, wherein the venting means provides a gas flow communication between two sides of the sealing lip, namely a side toward the head space (interior) and another side oriented towards the exterior, typically along the axial direction of the mixing tip (e.g. from the outlet towards the inlet(s)). The venting means is preferably embodied to provide a gaseous connection between the head space and the exterior ambient atmosphere outside the static mixing tip, such that a portion of gases trapped in a head space present between the housing and the static mixer has a pathway and may escape to the exterior ambient atmosphere during normal operation. One skilled in the art would understand that any continuous pathway will suffice for the ready passage of a gas even if it is relatively narrow, long and tortuous. The incoming material flows in through inlets, provided on the static mixer, into a head space, present between the static mixer and the housing. The air present in the head space is pushed out through the vents present on the sealing lip and/or the housing. The vents are thus sealed by the material after the air trapped has escaped. The disclosure also provides for the use of such static mixing tips in order to achieve these benefits.

Without wishing to be bound by any particular mechanism, the inventors believe that the long and tortuous pathway from the head space to the exterior atmosphere in the axial direction along the length of the static mixer base and through the narrow passages on the venting means which inhibit the flow outward and loss of the high-value and irritating masses out from the mixing tip while still allowing the ready passage of the low viscosity air out from the headspace to the exterior atmosphere. Therefore, the venting mechanism in this disclosure acts a filtering system to retain a viscous mass in the mixing tip w % bile allowing air to readily escape.

In one embodiment of the present disclosure the venting means is a plurality of vents which are radially oriented around the sealing lip and/or the housing. Such radial orientation advantageously enables even distribution of the vents.

These vents extend inwards and have a depth (D) and a width (W), which is the length of the opening of the vent on the surface of the sealing lip and/or the housing. In some embodiments of the present disclosure, the vents have a depth (D) and/or width (W) of 0.005 mm to 0.1 mm, preferably 0.01 mm to 0.06 mm. These dimensions beneficially enable the air to vent out while preventing the material from leaking out of the static mixing tip at normal operating pressure.

In some embodiments of the present disclosure the vents can be equal in size, which are easy to manufacture. In preferred embodiments of the present disclosure the vents can be unequal in size. Vents of varying size make it possible to compensate for pressure differences arising in different regions of the static mixing tip. When the material enters the static mixing tip through the inlets, it exerts pressure on air present inside the tip. The air gets pushed by the incoming material, and the pressure may not be equally distributed inside the tip. For example, the air farthest from the inlets experiences more pressure compared to the air nearer to the inlets. Therefore, in some preferred embodiments, the vents nearer to the inlets are smaller than the vents farther from the inlets in order to compensate for this pressure difference.

In yet another embodiment of the present disclosure, the vents can be unequal in size, wherein the vents, nearer to a region where two materials to be mixed physically interact, are larger than the vents nearer to the inlets. The vents being in the proximity of the inlets are the smallest as compared to other vents, and their size increases progressively, such that the size of the vents is largest in the region where two materials to be mixed physically meet and interact. The region in which the two materials first physically meet and interact is determined by the material ratio and thus the type of cartridge with which the static mixing tip is configured to connect. Cartridges and static mixing tips having different ratios have different positions and relative sizes of their respective inlets and outlets so that only the correct static mixing tip are compatible with the correct cartridges. For example, as determined by computational modeling or experiment, if the materials to be mixed are in the ratio 1:1, then, the region where two materials physically interact would be in the central region approximately equidistant from the two inlets. On the other hand, if the materials to be mixed are not equal in proportion, then the region where two materials to be mixed physically interact would be away from the center, nearer to the inlet of the material with smaller proportion. For example, if the materials to be mixed are in the ratio 4:1, then, the region where two materials physically interact would be nearer to the smaller inlet than the larger one, for example, within (⅓, preferably ¼ of the distance between the nearest edges of the smaller and the larger inlet). A person skilled in the art may readily locate the region where two materials physically interact, based on the ratio of the two materials, for example, if the materials to be mixed are in the ratio 2:1, the region where two materials physically interact would be between the center and the region where materials of ratio 4:1 interact. In some embodiments the vents will progressively increase in size from those nearest to the inlets to those nearest to where the two materials to be mixed first physically meet and interact.

In one embodiment of the present disclosure, the vents can be present on the inner surface of the housing. These vents can be present on the inner surface of the base of the housing and located on an inner surface of the base such that a portion of the vents overlaps with a portion of the interface between the sealing lip and the housing along the axial direction of the static mixing tip. This overlap will ensure that the trapped air finds a path through the vents to escape instead of being stopped by the sealing lip.

In one embodiment of the present disclosure the vents are approximately equally, preferably equally, distributed around the sealing lip and/or the housing. This equal distribution ensures that the air can escape out evenly and from all regions of the mixing tip.

In another embodiment of the disclosure, the vents which are embodied so that the material entering the static mixing tip pushes air out through the vents and seals the vents. The volume of the headspace is relatively large compared to that of the vents and the generally narrow and tortuous pathways for the air to escape. Therefore as the air in the headspace is displaced and compressed by the entering mass during use, it will readily escape through the vents. One skilled in the art will readily understand how to size the relative geometric parameters of the vents and their passageways, such as diameter, length and degree of tortuousness, so that the mass may displace the air and then partially fill and block the vents and their passageways depending on the viscosity of the mass intended to be used with the static mixing tip. For example, a filter path can be formed from a series of narrow labyrinth-like channels to trap material entering through the air passage openings.

In one embodiment of the present disclosure the housing has a base and a body and wherein an inner surface of the housing that connects the base to the body and is substantially truncated conical. The conical geometry guides the incoming material forward smoothly and into the body of the housing where the materials mix. It has been surprisingly found that the truncated conical geometry creates more free volume at the center, which offers less resistance to flow. This unique feature allows the incoming material to first occupy the volume that offers least resistance, which in the present case is the center. The resistance faced by the incoming material increases away from the center, which offers the least resistance, toward the space between the housing and the sealing lip, which offers the maximum resistance. This incremental gradient of resistance from the center to the perimeter of the housing ensures that the incoming material propagates in a way such that it does not entrap the air present in the head space. The air present in the center is pushed out radially by the incoming material towards periphery and eventually towards the sealing lip. The material propagation offered by the truncated conical geometry thus advantageously obviates the entrapment of air, which is already present in the static mixing tip, in the material.

In a preferred embodiment of the present disclosure the lateral surface above the sealing lip present on the base of the static mixer may be substantially truncated conical in shape. In other words, this lateral surface between the top of the base of the static mixer and the sealing lip can be substantially truncated conical, such that the diameter of the static mixer in this embodiment increases from the top of the base, to the sealing lip. It has been surprisingly found that the truncated conical geometry creates more free volume between the top of the base of the static mixer, which offers less resistance to flow. This truncated conical surface thereby creates an annular gap extending around the circumference of the base having a substantially inverse triangular cross-section. This inverse triangular cross-section creates an increasing resistance to flow from the direction of the headspace to the sealing ring as the annular gap becomes progressively narrower towards the sealing ring. Therefore the truncated conical lateral surface allows an incremental reduction in free volume and thus an incremental increase in resistance. This incremental gradient of resistance from top of the base of the static mixer to the sealing lip advantageously ensures that the incoming material propagates in a way such that it does not entrap the air present in the head space or the annular gap between the base of the housing and the base of the static mixer. The lower viscosity air present in the annular gap between the base of the housing and the base of the static mixer is thus pushed downwards towards the sealing lip by the incoming higher viscosity material. The relative material and gas propagation rates provided by the truncated conical geometry thus advantageously obviates the entrapment of air, which may already be present in the static mixing tip, in the material.

In one embodiment of the present disclosure the housing has a base and a body and wherein an outer surface that connects the base to the body and has more than one rib. The ribs can be in the shape of counterforts. Counterforts are structures that extend from the base of the housing, inclining on to the body of the housing. The ribs provide better stability to the housing and enable the retaining ring to “sit” on the housing. In a preferred embodiment, the ribs which are present on the outer surface connecting the base to the body of the housing are equally spaced. Equal spacing of the ribs provides uniform stability to the retaining ring.

In one embodiment of the present disclosure the sealing lip and/or the housing comprise four or more vents. When four or more vents are equally distributed around the sealing lip and/or the housing, the trapped air can flow out smoothly from each quadrant and faster from all directions. This uniform outflow of air helps to establish a uniform pressure gradient on all sides and avoids entrapment or creation of air bubbles.

In one embodiment of the present disclosure the housing has a base and a body wherein an inner surface of the base of the housing, below the sealing lip and before it in the axial direction of flow—from the cartridge before the sealing lip, comprises alternating crests and troughs. In one embodiment, the crests and troughs extend axially before the sealing lip but do not overlap with it. In a preferred embodiment, the alternating crests and troughs are equally spaced around the circumference of the inner surface of the base of the housing. In some embodiments the crests have heights of between 0.05 mm and 0.35 mm, preferably 0.1 mm and 0.3 mm, more preferable 0.15 mm and 0.25 mm. In some embodiments the troughs have depths of between 0.05 mm and 0.35 mm, preferably 0.1 mm and 0.3 mm, more preferable 0.15 mm and 0.25 mm. In some embodiments the crests and troughs start below the portion of the hosing that is in contact with the sealing lip and may have lengths in the axial direction of between 1.5 mm and 3.5 mm, preferably 2 mm and 3 mm. Without wishing to be bound by any particular mechanism, the crests on the inner surface of the base of the housing, below the sealing lip, prevent the vents on the sealing lip from being damaged during assembly of the mixing tip (insertion of the mixer into the housing) and also may allow the air to vent out more easily after is passes through the vents. The inner surface of the base of the housing can have two or more equally distributed alternating crests and troughs preferably 5 or more, more preferably 7 or more. One skilled in the art will understand that the previously discussed vents in the sealing lip may similarly be constructed of crests and troughs.

In one embodiment of the present disclosure the vents are embodied so that air but not a viscous mass is able to pass through the vents under normal dispensing operations at pressures less than 2 bar. Viscous masses include adhesives, sealants, impression materials and their two-component precursors and mixtures, particularly during mixing and dispensing operations. These viscous masses may have viscosities of 0.1 Pa·s to 100.000 Pa·s at standard room temperature and pressure or alternatively a viscosity of at least 0.5, 1, 2 or 10 Pas. The incoming material pushes the air present inside the static mixing tip, out through the vents and seals the vents. The specific location and geometry (diameter and length) of the vents can be used to ensure that only air can escape at normal pressures w % bile the material. One skilled in the art will understand that air can readily travel through lengthy narrow tortuous pathways, but highly viscous masses cannot. Therefore, tailoring the geometric parameters of the vents and escape pathway enables only air to pass through but not the mass. One skilled in the art will understand that these geometric parameters may be readily selected depending on the viscosity of the mass to be retained and the operating pressure, for example, by computational modeling. At extreme high pressures, of about 2 bars or more, it is possible that the material may leak from the vents. But these high pressures are difficult to reach unless deliberately applied and thus are generally not of interest. Under normal circumstances such as dispensing using manual or battery-operated dispensers, the vents of the present disclosure function well and are sealed by the incoming material.

In one embodiment of the present disclosure, the vents can be substantially conical in shape and may be provided on the sealing lip and/or the housing. When the vents are present on the sealing lip, the base of the cone is on the surface of the sealing lip, while the tip of the cone is inside the sealing lip. When the vents are present on the housing, the base of the cone is present on the inner surface of the base housing while the tip extends in the housing. The conical geometry, extending inwards, ensures that only air can pass through the vents. In another embodiment of the present disclosure the vents can be of a substantially concave hemispherical shape or a cubical shape. In some embodiments, the vents can be a combination of the above-mentioned shapes.

In some embodiments of the present disclosure the vents may be present both on the sealing lip and the housing. The vents of the sealing lip may or may not (not necessarily) coincide with the vents on the base of the housing.

In one embodiment of the present disclosure the static mixer of the static mixing tip comprises a plurality of mixing elements for separating a material to be mixed into a plurality of streams, as well as a means or element for the layered junction of the same, including a transversal edge and guide walls that extend at an angle to the transversal edge, as well as guide elements arranged at an angle to the longitudinal axis and including openings, wherein the static mixer comprises a transversal edge and a following transversal guide wall and at least two guide walls ending in a separating edge each with lateral end sections and with at least one bottom section disposed between the guide walls, thereby defining at least one opening on one side of the transversal edge and at least two openings on the other side of the transversal edge. This special geometry of the static mixer results in a high mixing efficiency with reduced dead volumes and reduced pressure drop.

In some embodiments of the present disclosure the static mixer of the static mixing tip comprises a plurality of mixing elements for separating a material to be mixed into a plurality of streams, wherein each mixing element comprises: first and second guide walls with a common transversal edge, a separating edge at an end opposite the common transversal edge, wherein the guide walls form a curved and continuous transition between the separating edges and the common transverse edge, wherein the transversal edge divides the material to be mixed, and wherein the first and second guide walls and common transversal edge of a mixing element divide the material into six flow paths. The common transversal edge prevents plugging of the mixer while reducing pressure drop and dead volumes.

In certain particular embodiments of the present disclosure the static mixer of the static mixing tip comprises five or more mixing elements and these mixing elements may be preferably connected to one another via a common bar element. The common bar provides strength to the mixing element by making them stiffer, and thus the resistance to breakage of the mixing elements increases by the presence of the common bar.

The static mixing tip of the present disclosure can have more than one inlet. The inlets allow the materials to be mixed to enter the body which helps to push the air out through the vents. The disclosure provides the desired solution irrespective of the number of inlets or the number of materials that are to be mixed. For example, the static mixing tip can have two inlets or three inlets, to mix two or three components, and this would not affect the functioning of the vents as they are located on the sealing lip and/or the housing and do not get affected by the number of inlets.

In one embodiment of the present disclosure the static mixing tip is used for releasing air trapped inside the static mixing tip through the unique vents present on its sealing lip and/or the housing in order to dispense substantially air free mixtures.

The static mixer, the housing and the retaining ring of the present disclosure can be made using standard manufacturing processes such as injection, slush, compression, or blow molding or alternatively by thermoforming, vacuum forming or casting.

The static mixer, the housing and the retaining ring of the present disclosure can be made of plastic, metal or glass, preferably plastic. In a preferred embodiment, the static mixer, the housing and the retaining ring of the present disclosure can be made of a thermoplastic, preferably polypropylene (PP). These varieties of plastics are rigid when solid and may be easily molded into a desired shape. Also, they are relatively inexpensive, and thus these would be preferred materials.

One skilled in the art will understand that the combination of the subject matters of the various claims and embodiments of the disclosure is possible without limitation in the disclosure to the extent that such combinations are technically feasible. In this combination, the subject matter of any one claim or embodiment can be combined with the subject matter of one or more of the other claims or embodiments. In this combination of subject matter, the subject matter of any one static mixing tip, static mixer, kit of parts and use claim or embodiments can be combined with the subject matter of one or more other static mixing tip, static mixer, kit of parts and use claims or embodiments. By way of example, the subject matter of any one claim or embodiment can be combined with the subject matter of any number of the other claims or embodiments without limitation to the extent that such combinations are technically feasible.

One skilled in the art will understand that the combination of the subject matters of the various embodiments of the disclosure is similarly possible without limitation in the disclosure. For example, the subject matter of one of the above-mentioned static mixing tip, static mixer, kit of parts and use embodiments can be combined with the subject matter of one or more of the other above-mentioned static mixing tip, static mixer, kit of parts and use embodiments without limitation so long as technically feasible.

### BRIEF DESCRIPTION OF THE DRAWINGS

The invention will be explained in more detail hereinafter with reference to various embodiments of the invention as well as to the drawings.

FIG. 1 shows a schematic view of a cross-section of a static mixing tip through the static mixer, retaining ring and housing.

FIG. 2A shows a schematic view of a static mixer.

FIG. 2B shows an enlarged schematic view of the base of a static mixer.

FIG. 3A shows a schematic view of a housing.

FIG. 3B shows a schematic view of a cross-section of the housing.

FIG. 3C shows an isometric view of the housing.

FIG. 4 is a schematic diagram of materials (dotted arrows) and air (solid arrows) flowing through a static mixing tip.

FIG. 5A shows a schematic top view of a cross-section through a sealing lip, with vents being concave hemispherical in shape, present on the sealing lip.

FIG. 5B shows a schematic top view of a cross-section through a sealing lip, with vents being conical in shape, present on the sealing lip.

FIG. 5C shows a schematic top view of a cross-section through a sealing lip, with vents being cubical in shape, present on the sealing lip.

FIG. 5D shows a schematic top view of a cross-section through a sealing lip, with vents being concave hemispherical in shape, present on the housing.

FIG. 5E shows a schematic top view of a cross-section through a sealing lip, with vents being conical in shape, present on the housing.

FIG. 5F shows a schematic top view of a cross-section through a sealing lip, with vents being cubical in shape, present on the housing.

FIG. 5G shows a schematic top view of a cross-section through a sealing lip, with vents being concave hemispherical in shape, present on the sealing lip and the housing.

FIG. 5H shows a schematic top view of a cross-section through a sealing lip, with vents being conical in shape, present on the sealing lip and the housing.

FIG. 5I shows a schematic top view of a cross-section through a sealing lip, with vents being cubical in shape, present on the sealing lip and the housing.

FIG. 6A shows an enlarged schematic top view of a cross-section through a sealing lip, with vents being concave hemispherical in shape and equal in size.

FIG. 6B shows an enlarged schematic top view of a cross-section through a sealing lip, with vents having different sizes, wherein the static mixer is suitable for mixing two materials which are in ratio (1:1).

FIG. 6C shows an enlarged schematic top view of a cross-section through a sealing lip on the base of a static mixer with vents having different sizes, wherein the static mixer is suitable for mixing two materials of unequal ratio, for example 4:1.

FIGS. 7A, 7B and 7C show schematic diagrams of suitable static mixers with different types of mixing elements.

FIG. 8 shows an enlarged schematic view of a head space.

FIGS. 9A & 10A show images of X-ray examination and CT scans of a bead of two materials mixed using a model static mixing tip that does not have venting means nor a conical geometry on the inner surface of the housing.

FIGS. 9B & 10B show images of X-ray examination and CT scans of a bead of two materials mixed using a model static mixing tip that has a venting means but does not have a conical geometry on the inner surface of the housing.

FIGS. 9C & 10C show images of X-ray examination and CT scans of a bead of two materials mixed using a model static mixing tip that has a venting means and a conical geometry on the inner surface of the housing.

FIG. 11 shows an enlarged schematic view of the annular gap present between the base of the housing and a substantially truncated conical lateral surface above the sealing lip present on the base of the static mixer.

FIG. 12A shows an enlarged schematic view of the inner surface (60′) of the base of housing comprising crests (171) and troughs (172).

FIG. 12B shows bottom view of the inner surface (60′) of the base of housing comprising evenly distributed crests (171) and troughs (172).

### DETAILED DESCRIPTION

As used in the specification and claims of this application, the following definitions, should be applied:

Venting means or element 150 has the function of assisting a continuous escape or release pathway for gasses trapped in a space, in the present case to provide a gaseous connection or a gas flow communication between two sides of (e.g. through) the sealing lip 20, namely a side oriented toward the head space (interior) 140 and another side oriented towards the exterior, typically along the axial direction of the mixing tip (e.g. from the outlet 80 towards the inlet(s) 50), for example, preferably between an upper cavity or headspace 140 of base 60 the housing 110 and the exterior ambient atmosphere outside. The venting means 150 can be typically located in and/or around sealing lip 20, which would otherwise (in the absence of venting means 150) seal the upper cavity (headspace 140) of base 60 the housing 110 and would not allow the passage of air. The venting means (or specifically vents 155) can be located on the sealing lip 20 and/or the housing 110, for example, they can pass thru wholly or partially the sealing lip 20 and/or housing 110. The venting means (or specifically vents 155) thus specifically provide a gas flow communication between two sides of the sealing lip (20).

Exterior ambient pressure is the ordinary atmospheric pressure, for example, at sea level it is 1 atm and can decrease with increase in altitude, to around 0.3 atm. The pressure can also vary based on temperature. Under normal conditions, ambient pressure can be for example, pressure inside buildings such as a dentist office or on a construction site where the device disclosed herein may be used.

Normal operation of the static mixing tip would be in the mixing and dispensing of fluids, such as those for industrial, construction, medical, cosmetic, and dental applications, including adhesive, sealants, coatings, and impression materials or other reactive material components, using manual, battery or pneumatic dispensers. Normal operating pressure would be the pressures exerted by the dispensers, which can also depend on the viscosity of the material to be dispensed. Typical internal pressures of the static mixing tips my range from 2 atm to 25 atm. Typical viscosities of materials to be dispensed range from 0.1 Pa·s to 100,000 Pa·s at standard room temperature and pressure.

Radial means the direction perpendicular to the direction of the flow material or perpendicular to the longitudinal axis.

Axial means the direction parallel to the direction of the flow material or parallel to the longitudinal axis.

CT scan means computerized tomography scan.

The words “air” and “gas” are used interchangeably.

Crest(s) means a raised surface that sticks out from a surface, such as a protrusion or a projection.

Trough(s) means a depression in a surface or a hollow space cut into a surface, such as a groove or a channel.

“a”, “an”, and “the” as an antecedent can refer to either the singular or plural unless the context indicates otherwise.

Numerical values in the present application relate to average values. Furthermore, unless indicated to the contrary, the numerical values should be understood to include numerical values which are the same when reduced to the same number of significant figures and numerical values that differ from the stated value by less than the experimental error of the conventional measurement technique of the type described in the present application to determine the value.

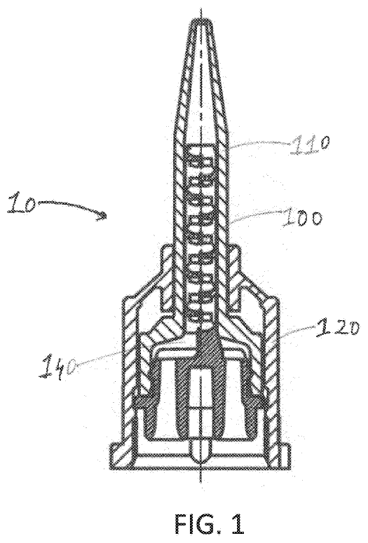

FIG. 1 is a view of a cross-section through an inlet of a static mixing tip 10. The static mixer 100 is arranged within the mixer housing 110. The housing 110 is received within a retaining ring 120, which serves to provide a connection to a cartridge, for example, one containing materials to be mixed and dispensed. The retaining ring 120 can have a bayonet coupling and/or other coding mechanism on it so as to ensure a proper and controlled coupling to the intended cartridge.

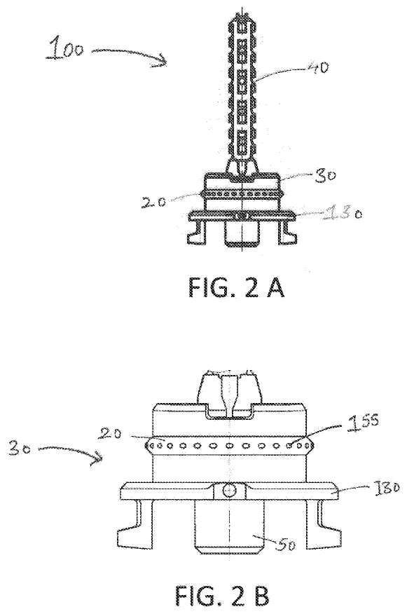

FIG. 2 A depicts a schematic view of a static mixer 100, wherein the static mixer 100 has a sealing lip 20, a base 30, a mixing body or an assembly of mixing elements 40, and a flange 130. The mixing body 40 will have a geometry suitable for mixing the incoming material. The geometry of the mixing body 40 is not specifically limited and can, for example, be helical or can comprise a plurality of components for separating a material to be mixed into a plurality of streams, wherein each mixing element comprises a transversal guide wall with a transversal edge, the transversal guide wall extending parallel to a longitudinal flow direction of the material to be mixed, and the transversal edge being an edge of the transversal guide wall that divides the material to be mixed; and first and second wall sections to further divide the material into six flow paths, each of the first and second wall sections including a guide wall perpendicular to the transversal guide wall, and an end section wall perpendicular to the guide wall, the end section wall being perpendicular to the transversal guide wall, and wherein the first and second wall sections are disposed opposite to each other.

FIG. 2 B depicts the base 30 of the static mixer 100. The base 30 can have one or more inlets 50 to receive the incoming material into the static mixer. The material to be mixed passes through inlets 50 and is released at the top of the base 30 of the static mixer 100, into the housing 110.

The base 30 has a sealing lip 20, around its circumference. This sealing lip 20 is located at a certain depth from the top of the base 30 of the static mixer 100. The sealing lip 20 can be preferably an integral part of the static mixer 100, or it can be separately manufactured and then attached to the static mixer 100. The sealing lip 20 can be a rim or a strip or of any suitable geometry that provides an effective sealing to prevent material from leaking backwards (opposite the direction of the desired material flow, for example, towards the attached cartridge or syringe) out of the mixing tip during its normal operation and use. On the sealing lip 20, there can be one or more venting means or elements 150, such as vents 155. The vents 155 are preferably conical, wherein the tip of the cone extends inside the sealing lip 20. The vents 155 could alternatively be concave hemispherical. The function of the vents 155 is to enable the passage of gas or air (a gas flow communication) between the two sides of (e.g. through) the sealing lip 20, but to prevent the passage of viscous material. One skilled in the art will understand that a variety of geometric shapes, particularly narrow or narrowing ones, can be utilized to achieve this function. If there exist more than one vent 155 on the sealing lip 20 then they can be preferably evenly distributed. At the bottom of the base 30 of the static mixer 100, there exists a flange 130 that supports the housing 110. The housing 110 sits on this flange 130.

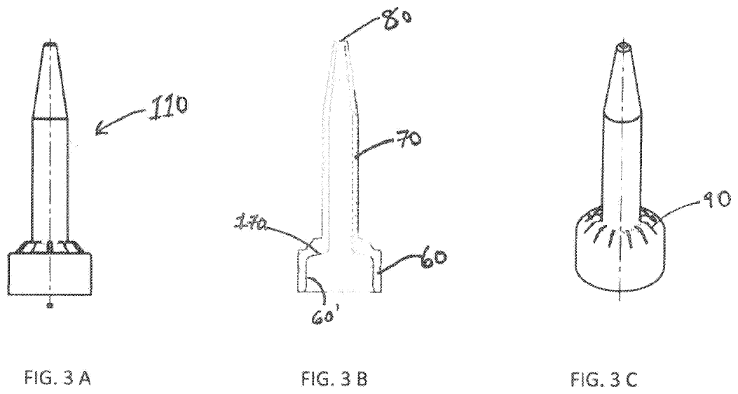

FIGS. 3 A and B depict a schematic view of a housing 110 wherein housing 110 has a base 60 and a body 70. The outer surface of the body 70 of the housing 110 can be substantially cylindrical or rectangular. The outer surface of the base 60 of the housing 110 can be substantially cylindrical. The outer surface of the base, that connects the base 60 to the body 70, can be substantially perpendicular to the body 70 of the housing 110.

FIG. 3 B shows a schematic view of a cross-section of the housing 110. The inner surface 170 of the housing 110 that connects the base 60 to the body 70 can be substantially conical. The housing 110 has an outlet 80 through which the mixed material leaves the static mixing tip. The surface connecting the outlet 80 to the body 70 of the housing 110 can be substantially conical or cylindrical.

FIG. 3 C depicts an isometric view of the housing 110 wherein the outer surface of the housing 110 that connects the base 60 to the body 70 can have one or more ribs 90. The ribs 90 can be inclined surfaces or shaped as counterforts connecting the base 60 to the body 70 of the housing 110. The ribs 90 can be equally spaced.

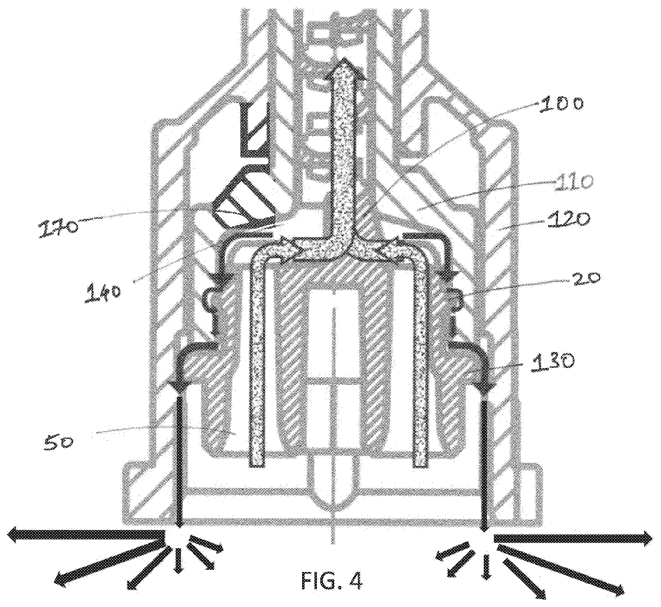

FIG. 4 shows a schematic diagram of the material (dotted arrows) and air (solid arrows) flowing through the static mixing tip 10. The incoming material (dotted arrows) flows in through inlets 50, provided on the static mixer 100, into the head space 140 between the base 60 and the body 70 of the housing 110. The air (solid arrows) present in the head space 140 is pushed out by the incoming material, downwards through the vents 155 present on the sealing lip 20 and/or the housing 110. The relatively narrow vents 155 are thus sealed by the viscous material. Thus, there is a gas flow communication between the two sides of the sealing lip 20 (i.e. through the sealing lip 20), but a hindrance or blockage of material flow communication. The air present in the head space 140 is therefore able to escape to the exterior ambient atmosphere, outside the static mixing tip 10 due to a gas flow communication between the two sides of the sealing lip 20. Thus, the gas flow communication between the two sides of the sealing lip 20 is part of a longer gas flow communication between the head space 140 and the bottom opening of the retaining ring 120. Any air trapped in the headspace 140 can thus flow towards and through the sealing lip 20 via the venting means 150 (vents 155), past the end of the base of the static mixer 30 and the flange 130, to the base of the housing 60 and the bottom end of the retaining ring 120, which is typically connected to the cartridge outlet(s) by a threaded or other mechanical connection means or device. This threaded or other mechanical connection means between the cartridge (containing material(s) to be mixed and dispensed) and the static mixing tip 10 is material-tight but not completely air tight. This air is therefore then forced out to the exterior atmosphere through the mechanical connection means, in part by the pressure of the central flow of material(s) from the cartridge into the static mixing tip 10. Thus the gas flow communication between the two sides of the sealing lip 20 is actually part of a much longer gas flow communication between the head space 140 and the exterior atmosphere, which thus allows trapped air in the headspace 140 to escape to the exterior atmosphere instead of being trapped as bubbles inside the dispensed material which comes out outlet 80.

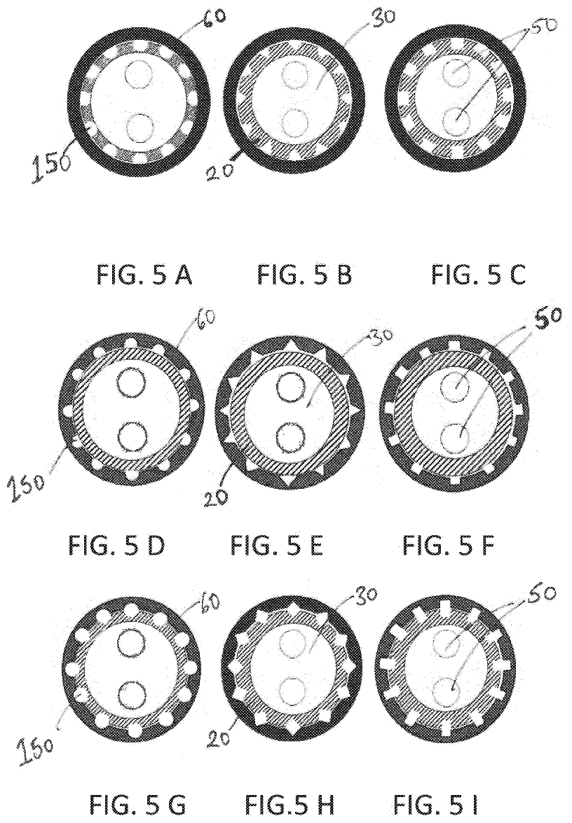

FIGS. 5 A, B and C are schematic top views of a cross-section through sealing lips 20 present on the base 60 of the static mixer 100 depicting representative different potential embodiments of the present disclosure, with vents 155 being concave hemispherical, conical and cubical, respectively. As can be seen from these figures, the geometry of the sealing lip and its vents 155 is not specifically limited provided that it fulfills the function of allowing gas or air to pass through (from one side to the other) while blocking the passage of the viscous mass or materials, and there can be one or more the vents 155 present on the sealing lip 20 and/or the housing 110. The vents 155 can be preferably equally distributed around the sealing lip 20 and/or the housing 110. The vents 155 can be of a variety of dimensions provided that they fulfill the “filtering” function of being large enough for air to pass, but small enough to stop viscous material from passing through them. The figures illustrate that the vents 155 can be of any shape that enables gas to pass through while blocking material. The cross-sectional area or lengths can therefore vary provided that they fulfill this filtering function.

As can be seen in FIGS. 5 D, E, F, G, H and I show that the vents 155 can be present on the inner surface of the base of the housing 60 such that a portion of the vents 155 overlaps with a portion of the interface 160 between the sealing lip 20 and the housing 110 along the axial direction of the static mixing tip 10. The vents 155 of the sealing lip 20 may or may not (not necessarily) coincide with the vents 155 on the base of the housing 60. One skilled in the art will understand that useful and optimal geometries and dimensions for venting means 150 and specifically vents 155 can be readily determined by computational modeling and experiment and will vary somewhat depending on the viscosity of the mass and the operating pressure in the static mixing tip 10.

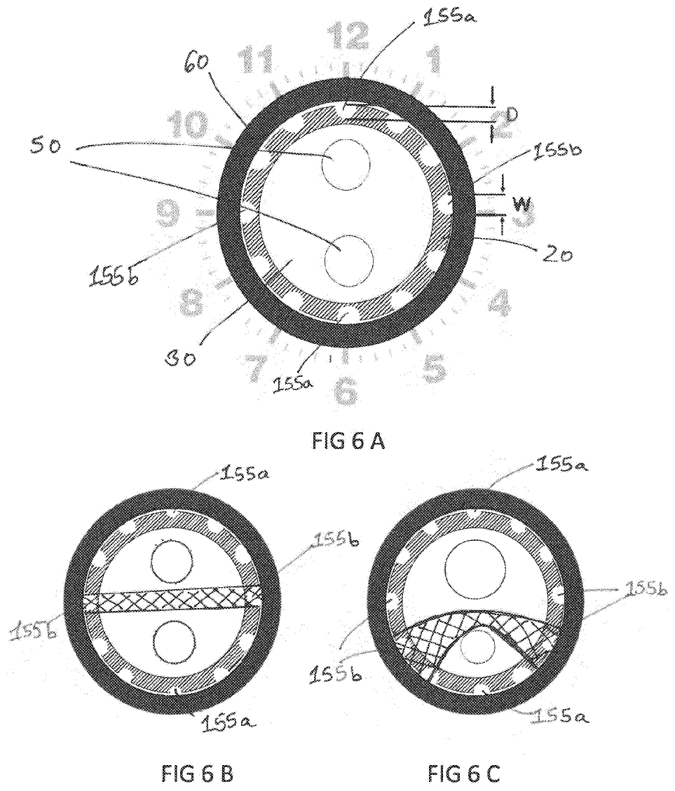

FIG. 6 A shows an enlarged schematic top view of a cross-section through a sealing lip 20 present on the base 60 of the static mixer 100. The venting means 150 in these figures are specifically vents 155. The depth (D) of the vent 155 is the distance between the surface of the sealing lip 20 and the innermost point of the vent. The width (W) is the length of the opening of the vent 155 on the surface of the sealing lip 20. In the case of unsymmetrical vents 155, the depth (D) and width (W) refers to the average depth and width. In the current figure, the inlets 50 are of equal size and are arranged symmetrically. Also, all of the vents 155 can be of equal size, as shown here. One can imagine the location of the vents 155 relative to a hypothetical clock. The vents closest to the inlets 155a can be located in the region near to 12 o'clock and 6 o'clock, while the vents farthest from the inlets 155b can be located in the region near to 3 o'clock and 9 o'clock.

FIG. 6 B shows an enlarged schematic top view of a cross-section through a sealing lip 20 present on the base 60 of the static mixer 100 with vents 155 having different sizes, wherein the static mixer 100 is suitable for mixing two materials which are equal in ratio (1:1). Therefore, the inlets 50 are of equal size and are arranged symmetrically. As can be seen from the figure, the vents closest to the inlets 155a are smaller than the vents farthest from the inlets 155b. The size of the vents can progressively increase from the vents closest to the inlets 155a being the smallest to that of the vents farthest from the inlets 155b being the largest. The size of the vents and their ability to pass air and block mass can be readily varied by increasing or decreasing the depth (D) and/or the width (W). The vents 155 can have a depth (D) and/or width (W) of about 0.005 mm to 0.1 mm, preferably between 0.01 mm and 0.06 mm. The vents 155 can be equal in size or preferably unequal, wherein the vents 155a near the inlets 50 are smaller than the vents 155b farther from the inlets 50. As determined by computational modeling or experiment, the area at the center, which is cross-hatched in this figure, depicts the region where two materials physically interact when the inlets are equal in size and the two materials to be mixed are equal in ratio.

FIG. 6 C shows an enlarged schematic top view of a cross-section through sealing lip 20 present on the base 60 of the static mixer 100 with vents 155 having different sizes, wherein the static mixer 100 is suitable for mixing two materials of which are unequal in ratio (for example 4:1). For mixing two materials in unequal ratios, the inlets 50 can be of different sizes. For example, relative to a hypothetical clock, if the larger inlet 50 is located in a region near to 12 o'clock and the smaller inlet 50 can be located in the region near to 6 o'clock. The vents 155a located in the region from 11 o'clock to 1 o'clock and in the region near 6 o'clock can be relatively smaller than the rest of the vents 155. The vents 155b located in the region from 4 o'clock to 5 o'clock and 7 o'clock to 8 o'clock can be larger than the rest of the vents 155. The size of the vents 155 can progressively increase, starting from the vents 155a at 12 o'clock being smallest, and thereon, increasing in size, in clockwise direction, up to a region between 4 o'clock and 5 o'clock, where the vents are largest 155b. Followed by a progressive decrease in the size of the vents 155 up to a region near 6 o'clock wherein the vents 155a are smallest. Further in the clockwise direction, the size of the vents increases progressively, up to the region near 7 o'clock to 8 o'clock where the vents 155b are largest. Thereafter the vents 155 can decrease in size progressively, until 12 o'clock. As determined by computational modeling or experiment, the area nearer to the smaller inlet, which is cross-hatched in this figure, depicts the region where two materials physically interact.

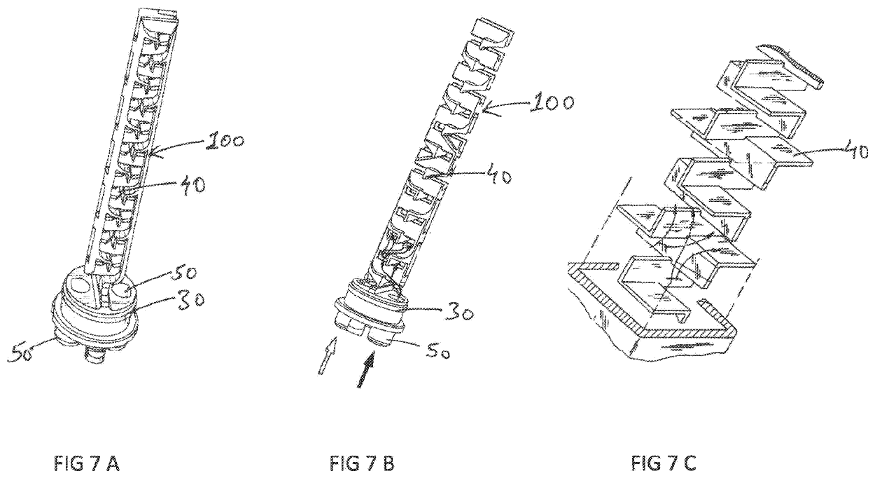

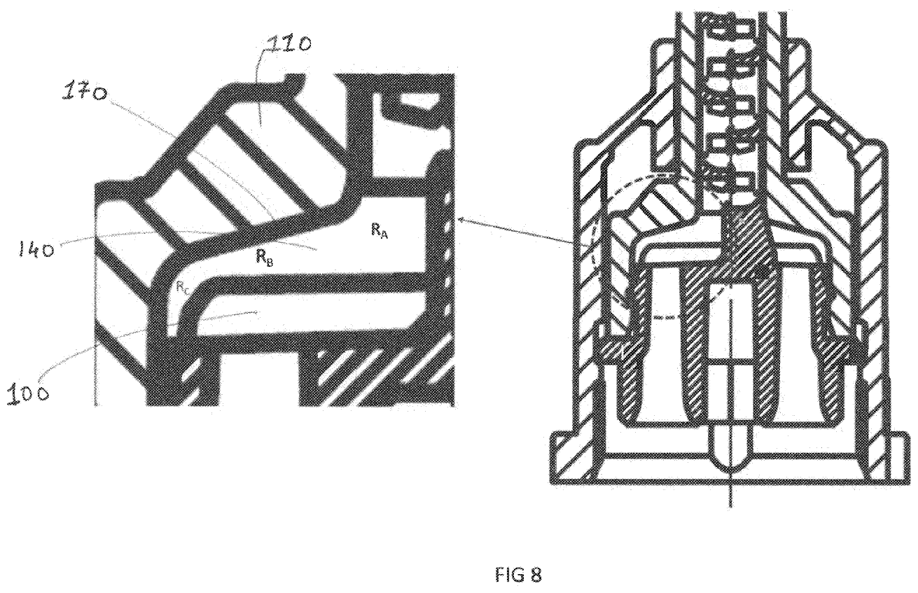

FIGS. 7 A, B and C are representative schematic diagrams of the geometries of assemblies of mixing elements 40 of the static mixer 100 in accordance with various embodiments. These geometries are disclosed in EP1426099 and EP0815929. For the purpose of this disclosure, the specific embodiment of the assembly of mixing elements 40 is not specifically limited as it does not significantly impact or influence the working of the disclosure as disclosed in this application.

FIG. 8 shows an enlarged schematic view of the head space 140. As can be seen from the figure, the inner surface 170 of the housing 110 that connects the base 60 to the body 70 and is substantially truncated conical. R_{A}, R_{B}, and R_{c} are resistances encountered by the incoming material (mass) at different locations in the head space 140. R_{A} is the resistance at a region around the center of the head space 140 (for example, near the center of the base 30 and/or near the assembly of mixing elements 40), R_{B} is the resistance away from the center of the head space 140. R_{c} is the resistance in the region between the base 60 of the housing and base 30 of the static mixer, which is above the sealing lip 20. Owing to the innovative shape of the housing there exists more free volume at the center of the headspace and hence the incoming material experiences least resistance at the center. Therefore R_{A} is least, which causes the incoming material to primarily occupy the region around the center of headspace first, thereby pushing the trapped air outward, towards the sealing lip 20. Resistance gradually increases, from the center towards the perimeter of the housing such that R_{B} is greater than R_{A}. As the free volume further decreases, resistance increases, such that the resistance R_{C}, in the region between the base 60 of the housing and base 30 of the static mixer, which is above the sealing lip 20, is greater than R_{B}. This incremental gradient of resistance (R_{A}<R_{B}<R_{c}) ensures that the incoming material propagates in a way such that it does not entrap the air present in the head space 140 and that the incoming material is ultimately stopped by the sealing lip 20 and prevented from flowing out backwards through the vents 155, which provide a gas flow communication between two sides of the sealing lip 20 (i.e. through the sealing lip 20) for the air. As is seen from this figure, a gradient in increasing resistance to flow is readily generated by using a headspace geometry that has a smaller cross-section (progressively becomes narrower) moving from the central region of the headspace towards the lower outer perimeter where the sealing lip 20 is located. Suitable geometric forms include substantially conical, substantially triangular pyramidical, substantially square pyramidical, substantially triangular prismatic and their variations including truncated ones, such as a substantially truncated conical shape.

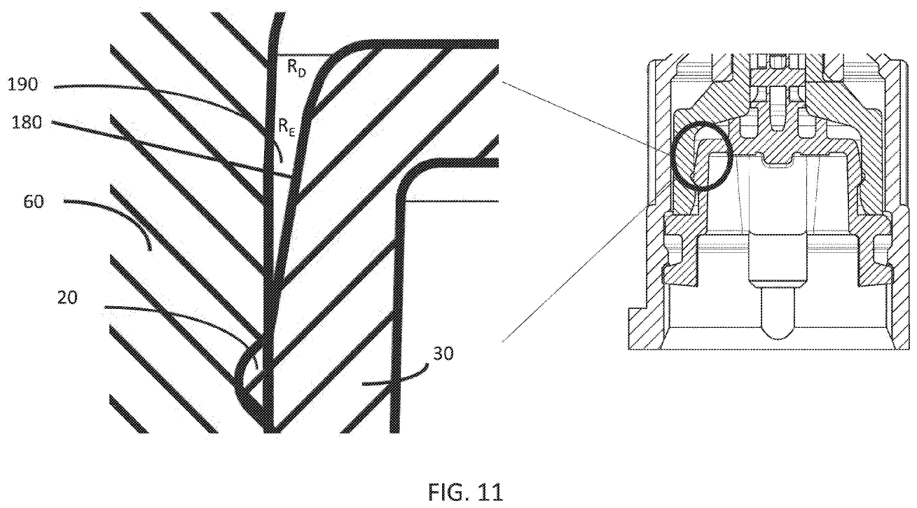

FIG. 11, shows an enlarged schematic view of the annular gap 190 between the base 60 of the housing and the base 30 of the static mixer. As can be seen from the figure, the lateral surface 180 between top of the base of the static mixer and the sealing lip 20 is substantially truncated conical. R_{D}, and R_{E}, are resistances encountered by the incoming material (mass) at different locations in the annular gap 190. R_{D} is the resistance at a region around the top portion of the annular gap 190 (for example, near the top of the base 30). R_{E} is the resistance in a region at the bottom of the annular gap 190, nearer to the sealing lip 20. Owing to the innovative shape of the lateral surface 180 between top of the base 30 of the static mixer and the sealing lip 20 there exists more free volume at the top of the annular gap 190 and hence the incoming material experiences less resistance R_{D} at the top as compared to the bottom R_{E} of the annular gap 190, thereby pushing the trapped air downward, towards the sealing lip 20. Resistance gradually increases, from the top of the annular gap 190 to the bottom of the annular gap 190 towards the sealing lip 20. This incremental gradient of resistance (R_{D}<R_{E}) ensures that the incoming material propagates in a way such that it does not entrap the air present in the annular gap 190 and that the incoming material is ultimately stopped by the sealing lip 20 and prevented from flowing out backwards through the vents 155, which provide a gas flow communication between two sides of the sealing lip 20 (i.e. through the sealing lip 20) for the air. As is seen from this figure, a gradient in increasing resistance to flow is readily generated by using a annular gap geometry that has a smaller cross-section (progressively becomes narrower) moving from the top of the annular gap 190 towards the sealing lip 20 is located. Suitable geometric forms include substantially conical, substantially triangular pyramidical, substantially square pyramidical, substantially triangular prismatic and their variations including truncated ones, such as a substantially truncated conical shape.

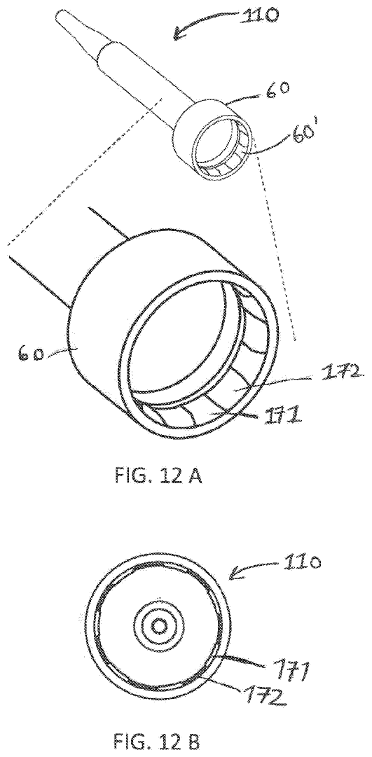

FIG. 12 A shows an enlarged schematic view of the inner surface 60′ of the base of housing comprising crests 171 and troughs 172. The crests 171 and troughs 172 are present below the point where the sealing lip 20 is in contact with the inner surface 60′ of the base of the housing (before the sealing lip 20 in the direction of flow from the cartridge). Due to the presence of the troughs 172, some portion of the sealing lip 20 does not come in contact with inner surface 60′ of the base of the housing, which prevents the vents 155 on the sealing lip 20 from getting smeared due to friction, particularly during assembly. Friction can damage the vents 155 and thus they might lose their capability to allow the air to pass. The troughs 172 allow the vents to remain intact, particularly for rigid or hard materials, such as in the case of breakable mixing tips like those disclosed, for example, in EP3826704. Therefore in one embodiment the mixing tip having vents and crests and troughs is a mixing tip that is breakable by the user so as to allow the outlet of the mixing tip to be increased in diameter.

FIG. 12 B shows bottom view of the inner surface 60′ of the base of housing comprising evenly distributed crests 171 and troughs 172 so they that the trapped air can flow out smoothly from all directions and to avoid damage around the entire circumference.

### Comparative and Working Examples

A comparative analysis was performed to evaluate the effect of incorporation of venting means 150, specifically vents 155, and substantially truncated conical geometry of the inner surface 170 of the housing 110, specifically above the head space 140, in various model static mixing tips 10.

X-ray images and CT scans were performed to measure the size and density of air bubbles in extruded beads from various different model static mixing tips. A standard material composition of a self-adhesive, self-curing resin cement (SpeedCEM Plus™, from Ivoclar Vivadent AG) in a standard cartridge having a 1:1 ratio and a commonly-available hand dispenser was used in these examples. The model static mixing tips tested all had identical assemblies of mixing elements as in FIG. 7 A.

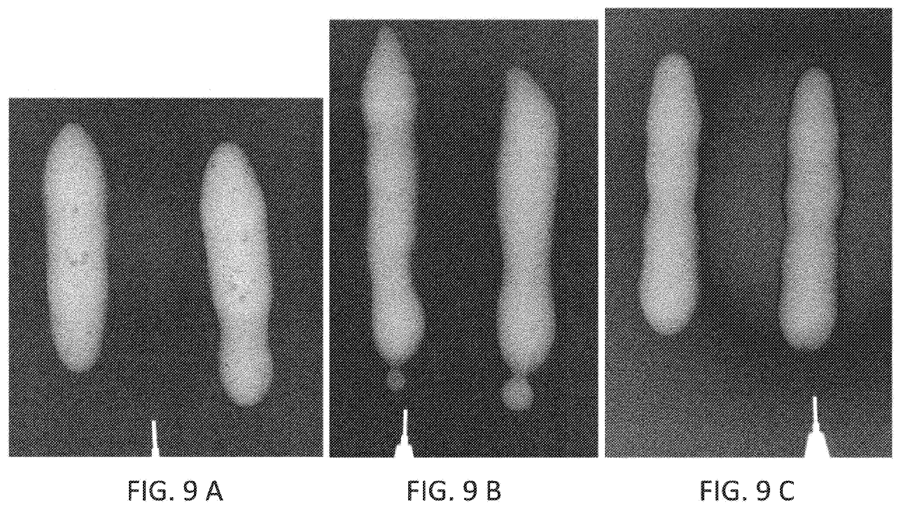

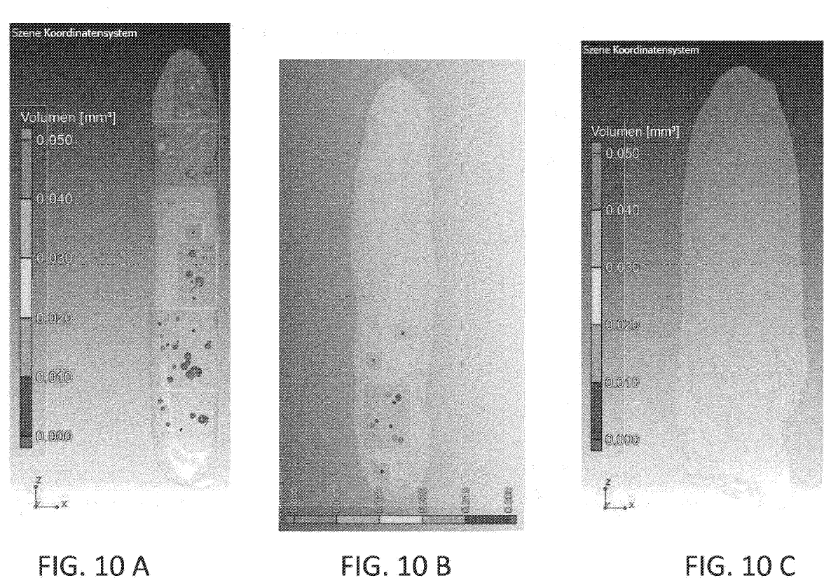

Comparative example 1: A static mixing tip without venting means and without a housing having a conical inner surface was tested for its performance in producing extruded beads on mixed material. FIGS. 9 A and 10 A are X ray images and CT scan images of a bead of two materials mixed using a static mixing tip that does not have venting means nor a conical geometry on the inner surface of the housing. Large air bubbles (volume of 0.04 mm; or greater) were entrapped throughout the length of the bead.

Comparative example 2: A static mixing tip without venting means, but with a housing comprising a conical inner surface was tested in this example. A bead was made of two materials using a static mixing tip that does not have venting means but has a substantially truncated conical geometry on the inner surface of the housing. Large air bubbles are observed throughout the length of the bead when X ray images and CT scan images are made. Therefore, providing a conical inner surface to the housing alone is not effective in preventing entrapment of air bubbles.

Working example 1: A static mixing tip with venting means, and without a housing comprising a conical inner surface was tested in this example. FIGS. 9 B and 10 B are X ray images and CT scan images of a bead of two materials mixed using a static mixing tip that has a venting means in accordance with the present disclosure, specifically vents like those shown in FIGS. 2 A and 2 B, but lacks a conical geometry on the inner surface of the housing. As can be seen from the figures, only small air bubbles (of volume between 0.01 mm³ and 0.04 mm³) were entrapped in a segment of the bead. Therefore, it is observed the venting means (vents) according to the present disclosure significantly reduces the size and volume or the air bubbles entrapped in the mixed material because they provides a gas flow communication between the two sides of the sealing lip (e.g. through the sealing lip), namely a side toward the head space (interior) and outlet and another side oriented towards the exterior and inlet(s).

Working example 2: A static mixing tip with venting means, specifically vents, and with a housing comprising a substantially truncated conical inner surface was tested in this example. FIGS. 9 C and 10 C are X ray images and CT scan images of a bead of two materials mixed using a static mixing tip that has venting means, vents as in working example 1, and a conical geometry on the inner surface of the housing. No bubbles were observed in the bead. Therefore, it is observed that the combination of venting means and a substantially truncated conical inner surface on the inner surface of the housing gives the best results in minimizing or even eliminating air bubbles.

1. A static mixing tip comprising:
a static mixer having a base;
a housing having a base (60) and a body;
a head space disposed between the housing and the static mixer;
a sealing lip disposed on the base of the static mixer to provide a seal between the base of the static mixer and the housing; and
at least one venting element disposed on the sealing lip of the static mixer or the housing,
the at least one venting element is configured to provide a gas flow communication between two sides of the sealing lip, and a gaseous connection between the head space and an exterior ambient atmosphere outside the static mixing tip such that a portion of gases trapped in the head space between the housing and the static mixer has a pathway to escape to the exterior ambient atmosphere during normal operation and operation of the static mixing tip.

2. The static mixing tip of claim 1, wherein the at least one venting element comprises vents radially oriented around the sealing lip or the housing.

3. The static mixing tip of claim 1, wherein the at least one venting comprises a plurality of vents, each vent of the plurality of vents having a depth or width of 0.005 mm to 0.1 mm.

4. The static mixing tip of any claim 1, wherein the at least one venting element comprises a plurality of vents equal in size.

5. The static mixing tip of claim 1, wherein the at least one venting element comprises a plurality of vents unequal in size, the vents nearer to a region where two materials to be mixed physically meet and interact being larger than the vents nearer to inlets of the static mixer.

6. The static mixing tip of claim 1, wherein the at least one venting element comprises a plurality of vents, each vent of the plurality of vents disposed on an inner surface of the base of the housing such that a portion of the at least one venting element overlaps with a portion of an interface between the sealing lip and the housing along an axial direction.

7. The static mixing tip of claim 1, wherein the at least one venting element comprises approximately equally distributed around the sealing lip of the static mixer or the housing.

8. The static mixing tip of claim 1, wherein the at least one venting element comprises a plurality of vents, each vent of the plurality of vents configured to enable material entering the static mixing tip to push air out through the plurality of vents and seal the vents.

9. The static mixing tip of claim 1, wherein the housing comprises a substantially truncated conical inner surface connecting the base to the body.

10. The static mixing tip of claim 1, wherein the housing comprises an outer surface connecting the base to the body, and the outer surface comprises one or more.

11. The static mixing tip of claim 1, wherein the at least one venting element comprises a plurality of vents configured to enable air but not viscous mass to pass through the vents during normal mixing and dispensing operations at pressures of less than 2 bar.

12. The static mixing tip of claim 1, wherein the static mixer comprises an assembly of mixing elements to separate a material to be mixed into a plurality of streams, each mixing element comprising first and second guide walls with a common transversal edge, a separating edge at an end opposite the common transversal edge, the first and second guide walls form a curved and continuous transition between the separating edges and the common transverse edge, the transversal edge is configured to divide the material to be mixed, and the first and second guide walls and common transversal edge of a mixing element divide the material into six flow paths.

13. A static mixer suitable for a static mixing tip, comprising:
a base;
a sealing lip in the form of a protruding ridge or rim or strip around a circumference of the base, the sealing lip at least one opening in a radial orientation through the sealing lip configured to enable a gas to pass through the sealing lip.

14. A method, comprising:
operating the static mixing tip of claim 1 such that two or more components are mixed while substantially releasing air trapped inside the static mixing tip to yield a substantially air-free homogeneous mixture.

15. A kit of parts comprising:
the static mixing tip of claim 1; and
a cartridge containing a dental, medical or construction material, the cartridge having an outlet configured to connect to an inlet of the static mixing tip.

16. The static mixing tip of any claim 1, wherein the at least one venting element comprises a plurality of vents, vents of the plurality of vents nearer to inlets of the static mixer being smaller than the vents farther from the inlets.

17. The static mixing tip of claim 1, wherein the at least one venting element comprises a plurality of vents disposed approximately equally distributed around the sealing lip of the static mixer or the housing, the sealing lip or the housing comprises four or more vents, and an inner surface of the base comprises two or more equally distributed alternating crests and troughs.

18. The static mixing tip of claim 1, wherein the housing comprises a substantially truncated conical inner surface connecting the base to the body, and a lateral surface of the base of the static mixer above the sealing lip is substantially conically truncated.

19. The static mixing tip of claim 1, wherein the housing comprises an outer surface connecting the base to the body, and the outer surface comprises two or more equally spaced ribs.

20. The static mixing tip of claim 1, wherein the static mixer comprises an assembly of mixing elements to separate a material to be mixed into a plurality of streams, each mixing element comprising first and second guide walls with a common transversal edge, a separating edge at an end opposite the common transversal edge, the first and second guide walls form a curved and continuous transition between the separating edges and the common transverse edge, the transversal edge is configured to divide the material to be mixed, and the first and second guide walls and common transversal edge of a mixing element divide the material into six flow paths, and the assembly of mixing elements includes five or more mixing elements connected to one another via a common bar element.
